(19) United States
(12) Patent Application Publication
(10) Pub. No.: US 2016/0070860 A1
(43) Pub. Date: Mar. 10, 2016

(54) STRUCTURING MULTI-SOURCED MEDICAL INFORMATION INTO A COLLABORATIVE HEALTH RECORD

(71) Applicant: WebMD Health Corporation, New York, NY (US)

(72) Inventors: Bassam A. Saliba, Kirkland, WA (US); John Yii, Newcastle, WA (US); Nicholas M. Altebrando, Long Island City, NY (US); Gopal Annasundaram, Sammamish, WA (US); Sreekanth Ayydevara, Mercer Island, WA (US); Danh T. Vo, Renton, WA (US)

(21) Appl. No.: 14/480,386

(22) Filed: Sep. 8, 2014

(51) Int. Cl. G06F 19/00

(52) U.S. Cl. CPC G06F 19/322

(57) ABSTRACT

Described herein are techniques for storing and communicating content, such as medical information, for an individual person (e.g., a recipient of medical service, a healthcare patient, etc.). The medical information may be stored in, and communicated to and from, a collaborative medical record. A “collaborative” medical record is a medical record capable of receiving the user-specific medical information from multiple different sources (e.g., medical service providers, patients, etc.). To create and maintain collaborative medical records, and to communicate user-specific medical information, the techniques described herein generate and use generic medical information schemas. A generic medical information schema is defined so that related medical information can be organized so that it can efficiently and reliably be stored and/or retrieved via a user instance of the generic medical information schema in a collaborative medical record.

### BACKGROUND

More and more medical service providers are generating and storing electronic copies of medical records instead of paper copies. The medical records contain user-specific health information that is often made up of information provided by multiple different medical service providers. For example, a patient may visit multiple doctors so that one or multiple health-related conditions can be diagnosed and/or treated. It is beneficial for the medical service providers to share user-specific health information such that information determined via a first visit to a first doctor can be accessed and reviewed in association with a second visit to a second doctor. As more user-specific medical information is shared and communicated amongst multiple medical service providers, storing, consolidating, and structuring the user-specific medical information in an organized manner becomes difficult.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a diagram that shows an overview of a medical record communication service that is configured to receive user-specific medical information, store the user-specific medical information in an associated collaborative medical record, retrieve the user-specific medical information from the associated collaborative medical record, and/or provide the user-specific medical information to various medical service providers or other healthcare-related entities.

FIG. 2 illustrates an example diagram that shows generic medical information schemas generated and used by the medical record communication service to create, to maintain and to communicate collaborative medical records that individually include user-specific medical information for various users.

FIG. 3 illustrates an example diagram that shows example user instances of generic medical information schemas that contain user-specific medical information comprising at least part of a collaborative medical record for an individual user.

FIG. 4 illustrates an example diagram that shows a component level view of a computing device of the medical record communication service.

FIG. 5 illustrates an example diagram that shows interactions with a user instance of a generic medical information schema to store and/or retrieve user-specific medical information for varying forms and/or varying formats.

FIG. 6 illustrates an example diagram that shows a generic medical information schema being extended.

FIG. 7 illustrates an example process that retrieves and provides user-specific medical information in response to receiving a request.

FIG. 8 illustrates an example process that uses a generic medical information schema to store user-specific medical information in a collaborative medical record in response to receiving the user-specific medical information, e.g., from a medical service provider.

FIG. 9 illustrates an example process that uses a generic medical information schema to store user-specific medical information received from a first medical service provider in a first format and that retrieves the stored user-specific medical information so that it can be provided to a second medical service provider in a second format that is different than the first format.

FIG. 10 illustrates an example process that extends a generic medical information schema and/or extends a user instance of the generic medical information schema.

FIG. 11 illustrates an example diagram that provides a form service to medical service providers based on the generic medical information schemas.

### DETAILED DESCRIPTION

This disclosure describes, in part, techniques for storing and communicating content, such as medical information, for an individual person (e.g., a recipient of medical service, a healthcare patient, etc.). The medical information may be stored in, and communicated to and from, a collaborative medical record. Medical information for an individual person may be referred to herein as user-specific medical information and may include, for example, information related to medications, information related to health conditions, information related to medical service providers, information related to previous treatments, information related to previous appointments, emergency contacts, preferred pharmacies, etc. A “collaborative” medical record is a medical record capable of receiving the user-specific medical information from multiple different sources (e.g., the sources provide the user-specific medical information). For example, the multiple different sources may be medical service providers or other healthcare-related entities that jointly provide the user-specific medical information so that it can be stored for a user in one or more user collaborative medical records and shared with others (e.g., other medical service providers, the patient, a caretaker, a parent of an infant, etc.). A source of information may also be any user-generated content, such as tracking information the patient is maintaining (e.g., blood pressure or temperature), and information sourced from biometric devices (e.g., glucose monitor).

Therefore, the techniques discussed herein describe a medical record communication service configured to receive user-specific medical information for an individual user from a variety of different medical service providers or other sources (e.g., the patient, the caregiver of the patient, a biometric device, etc.). The medical record communication service may then store the user-specific medical information for the individual user in a corresponding collaborative medical record. The medical record communication service is also configured to receive a request for user-specific medical information for the individual user and, in response to receiving the request and/or upon validating the right to access the information, the medical record communication service accesses the user-specific medical information in the corresponding collaborative medical record and provides at least a portion of the user-specific medical information requested.

In various implementations, the user-specific medical information communicated via the medical record communication service may be heterogeneous information such that it may vary in format. For example, a first medical service provider may request and/or provide user-specific medical information in a first format (e.g., a format preferred by the first medical service provider) and a second medical provider may request and/or provide the same or similar user-specific medical information in a second format that is different than the first format. The varying formats may be part of, or in some way associated with, forms used by a medical service provider (e.g., an appointment check-in form, an appointment scheduling form, a doctor's form summarizing an appointment, a healthcare payment form, etc.).

As used herein, a “format” of the user-specific medical information that is requested and/or provided by a medical service provider may be based on one or more of: an amount of information (e.g., a number and type of data elements as further discussed herein), terminology or text used to represent or describe medical information (e.g., naming conventions, labels, abbreviations, acronyms, etc.), metrics or units used to convey amounts or levels, or other attributes that may vary from one format to another. As an example, a first form used by a first medical service provider to specify current medications being taken by an individual user may only request a type of medication being taken by the individual user while a second, different form used by a second medical service provider to specify current medications being taken by the individual user may request a type of medication being taken by the individual user, a dosage of each medication being taken, and a starting date for taking each medication. Thus, even though the first form and the second form in this example are directed to requesting and/or providing similar or the same user-specific medical information (e.g., medications currently being taken or consumed by the user), the forms vary in format at least because they are generated to request and/or provide different amounts of user-specific information related to medications. In another example, a first form used by a first medical service provider may specify a dosage of a medication in accordance with a first metric unit, e.g., milligrams (mgs), while a second, different form used by a second medical service provider may specify the dosage of the same medication in accordance with a second metric unit, e.g., milliliters (mls).

To create and maintain collaborative medical records, and to communicate user-specific medical information that may vary in format, the medical record communication service described herein is configured to generate and use generic and extensible medical information schemas. A generic medical information schema is defined so that related medical information can be organized so that it can efficiently and reliably be stored and/or retrieved. A generic medical information schema is labeled “generic” because the information contained therein is not specific to a user, but rather is applicable to any user for which a collaborative medical record may be stored. Thus, the information contained in a generic medical information schema (also referred to herein as a “generic schema”) provides organization and structure so that user-specific medical information can be stored in and retrieved from a collaborative medical record. Stated another way, the medical information communication service is configured to create and maintain, as part of a collaborative medical record, a user instance of a generic medical information schema (also referred to herein as a “user instance medical information schema” or just a “user instance schema”). Accordingly, the medical information communication service may instantiate a generic medical information schema for multiple users.

By generating and using the generic medical information schemas, the medical information communication service can organize and consolidate user-specific medical information that is related. As a result of being stored in an organized and consolidated manner, the retrieval of related user-specific medical information is more reliable and efficient in response to receiving a request. For example, instead of a user having to remember his or her medical information (e.g., current medications being taken) and having to take the time to write or list them in a form at a doctor's office, the techniques described herein can efficiently receive an authorized request and can reliably process the request to retrieve all the relevant user-specific medical information requested. In some implementations, the techniques may auto-populate or pre-fill fields on a form with the user-specific medical information requested. Continuing the example above, the doctor or patient may update the user-specific medical information in the form (e.g., change a dosage of a medication, update the blood pressure reading on an intake form, etc.) or provide new user-specific medical information to the form during or after the appointment (e.g., prescribe a new medication to the user) and once the form is saved and submitted by the doctor or patient, the updated or new user-specific medical information can be returned and stored in the user's collaborative medical record.

Consequently, the medical record communication service described herein uses generic medical information schemas to continuously (i) receive user-specific medical information and store the received user-specific medical information in a collaborative medical record, and (ii) retrieve user-specific medical information from the collaborative medical record and provide the retrieved user-specific medical information. As discussed above, this continuous communication may be performed over a period of time and/or with a plurality of different medical service providers that may request and/or provide information in varying formats (e.g., use different forms).

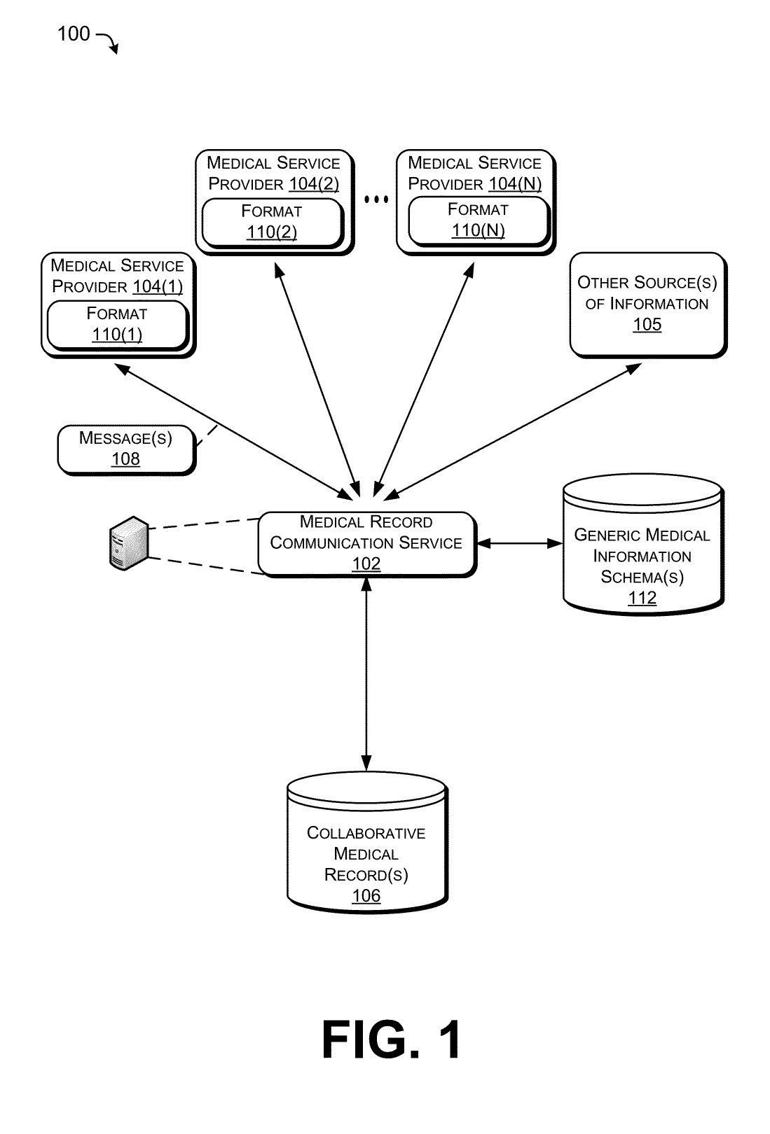

FIG. 1 illustrates a diagram 100 that shows an overview of a medical record communication service 102 that is configured to receive user-specific medical information from, and/or provide user-specific medical information to, various medical service providers 104(1) . . . 104(N) (e.g., N is an integer number). Thus, the medical service providers 104(1) . . . 104(N) may be the source of the user-specific medical information. The medical record communication service 102 may also be configured to receive user-specific medical information from, and/or provide user-specific medical information to, other sources 105 such as a patient or a caregiver of patient (e.g., via a personal device), a biometric device, etc. Thus, the information received may be generated by a service provider or generated by a user. The user-specific medical information may be stored and maintained in collaborative medical records 106 for individuals referred to herein as a user (e.g., medical service recipients, healthcare patients, etc.). The users may be human or other individuals receiving medical service such as a pet (e.g., a dog, a cat, a horse, etc.).

In various implementations, the medical record communication service 102 may communicate the user-specific medical information via messages 108, where a message in some way indicates or specifies the medical information being requested or the medical information being provided. For instance, a message 108 may be a requesting message where a medical service provider (e.g., one of 104(1) . . . 104(N)) requests that the medical record communication service 102 provide user-specific medical information (e.g., prior to a doctor's appointment). Alternatively, a message 108 may be a providing message where a medical service provider (e.g., one of 104(1) . . . 104(N)) provides user-specific medical information specific to the medical record communication service 102 so that the user-specific medical information can be stored in a collaborative medical record 106 (e.g., after a doctor's appointment).

As discussed above, the medical service providers 104(1) . . . 104(N) or another source 105 may request and/or provide user-specific medical information, e.g., the same or similar related user-specific medical information, in various formats 110(1) . . . 110(N). To improve healthcare and medical-related services provided to a user by the medical service providers 104(1) . . . 104(N), the medical record communication service 102 is configured to (i) determine if user-specific medical information is related and consolidate related user-specific medical information (e.g., by type, by medical condition, by treatment, etc.), (ii) determine if user-specific medical information is a duplicate and de-duplicate repetitive or redundant user-specific medical information (e.g., the same medication reported or prescribed by two different doctors to treat the same condition), and (iii) normalize the user-specific medical information (e.g., using standard taxonomies or canonical codes). Therefore, the medical record communication service 102 generates and uses generic medical information schema(s) 112 to organize (e.g., consolidate, de-duplicate and/or normalize) the user-specific medical information requested and/or provided by various medical service providers 104(1) . . . 104(N) via various formats 110(1) . . . 110(N). In some implementations, two or more of the medical service providers 104(1) . . . 104(N) may request and/or provide the user-specific medical information in a same format. In various scenarios, the source of the information may be tracked along with the specific medical information, and metadata may be made available along with the record as an indicator of the quality and validity of the data.

As used herein, a medical service provider 104(1) . . . 104(N) may include an individual person, such as a physician, a doctor, a healthcare team member, a physician's assistant, a nurse, a dentist, a hygienist, a nutritionist, a psychologist, a physical therapist, a chiropractor, a lab worker, a medical technician, a pharmacist, a person assisting any of these care providers, or any other sort of person working in the medical field to medically service an individual person (e.g., a medical service recipient, a healthcare patient, etc.). A medical service provider 104(1) . . . 104(N) may also be an entity comprising or employing one or more individual persons discussed above such as a doctor's office, a dentist's office, a hospital, a clinic or department within a hospital, a research lab, a non-profit organization, a non-government organization, or any other entity that operates in a medical service environment in which the individual persons discussed in this paragraph may work.

In various implementations, one or more collaborative medical records 106 may be associated with a user account hosted by an entity operating the medical record communication service 102. By hosting a user account, the user-specific medical information may be secured and/or accessible to an authorized user (e.g., the patient, a parent or guardian of an infant, a caretaker for an elderly person, the patient's doctors or other healthcare professionals that provide care to the patient, etc.). In one example, the entity operating the medical service communication service 102 may be a third-party entity. In another example, the entity operating the medical service communication service 102 may be a medical service provider (e.g., one of medical service providers 104(1) . . . 104(N)).

As discussed above, a message 108 requesting or providing user-specific medical information may include or in some way be associated with a form. For example, a message 108 may be associated with an appointment check-in form and may request user-specific medical information related to the appointment so that a doctor can review the information prior to, or at the beginning of, the appointment. In another example, a message 108 may be associated with an appointment scheduling form and may request user-specific medical information so that an appointment can be scheduled with an appropriate doctor or clinic (e.g., determine a previously treated condition or a new condition and identify a doctor with credentials to further diagnose and/or treat the condition). In yet another example, a message 108 may be associated with a form that summarizes a completed appointment such that a doctor or other medical professional may provide user-specific medical information to be stored in the collaborative medical record to be accessed at a later time (e.g., an analysis of what is causing pain, a diagnosis, medications prescribed, treatment plan, etc.).

In some example scenarios, the forms may be associated with, or based on, a continuity of care document (CCD), a consolidated clinical document architecture (C-CDA), a continuity of care record (CCR), FHIR, and/or a health level seven (HL-7) standard.

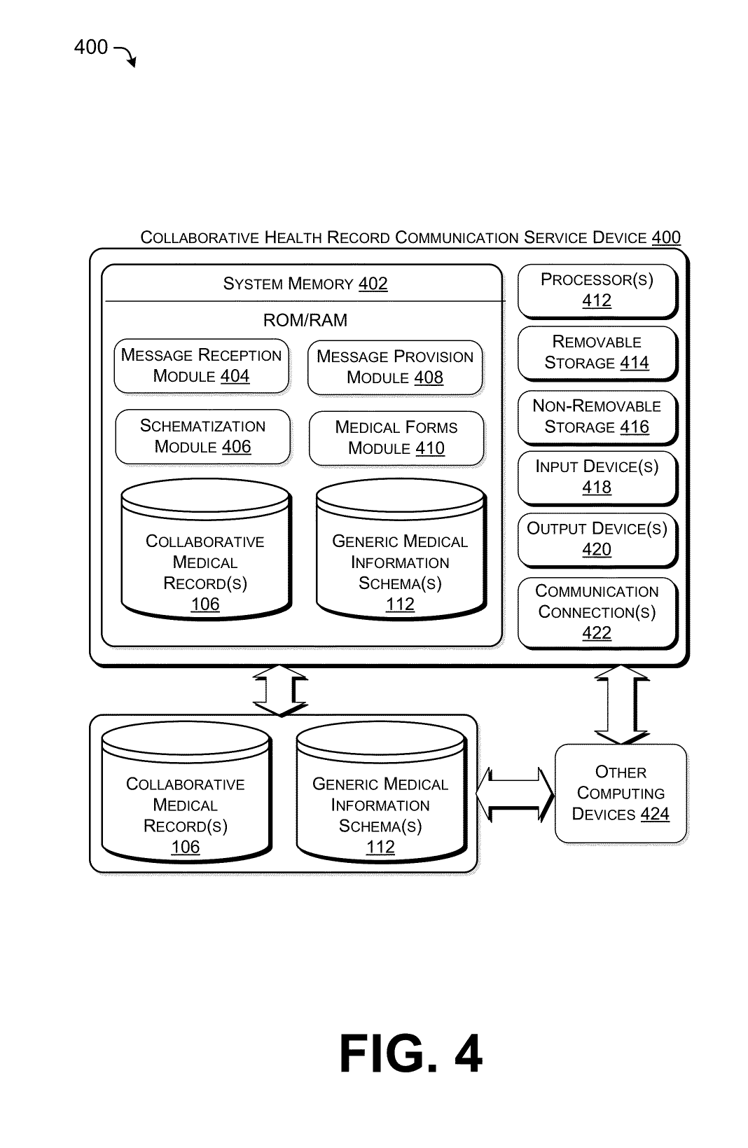

The medical record communication service 102 may be implemented by one or more computing devices. Such computing device(s) may each be or include a server or server farm, multiple, distributed server farms, a mainframe, a work station, a personal computer (PC), a laptop computer, a tablet computer, an embedded system, or any other sort of device or devices. In one implementation, the computing device(s) include a plurality of computing devices working in communication, such as a cloud computing network of nodes. An example computing device of the medical record communication service 102 is illustrated and further described in detail below with reference to FIG. 4.

Furthermore, a medical service provider 104(1) . . . 104(N) or another source 105 may be associated with one or more computing devices. For example, a computing device may be placed in an office or other medical service environment where the computing device can display prompts for information and the information may be entered by a medical professional (e.g., the individuals discussed above), the patient or recipient of healthcare, an employee or other representative of a doctor's office, etc. Such computing device(s) may each be or include a server, a work station, a desktop computer, a laptop computer, a tablet computer, a cellular phone, a smart phone, a biometric device, a media player, an electronic reading device, an office device, a printer, a scanner, a photocopier, an embedded system, or any other sort of device or devices. In one implementation, the computing device(s) include a plurality of computing devices working in communication, such as a cloud computing network of nodes.

In some examples, the medical record communication service 102 may be connected to the medical service providers 104(1) . . . 104(N) by one or more networks. Such network(s) may include wired network(s), wireless network(s), or any combination of wired and wireless network(s). The network(s) may also be public network(s), private network(s), or any combination of public and private network(s). Further, the network(s) may include the Internet, wide area networks (WANs), local area networks (LANs), personal area networks (PANs), or any combination of the Internet, WANs, LANs, or PANs. Additionally, the network(s) may include telecommunication network(s), such as cellular network(s).

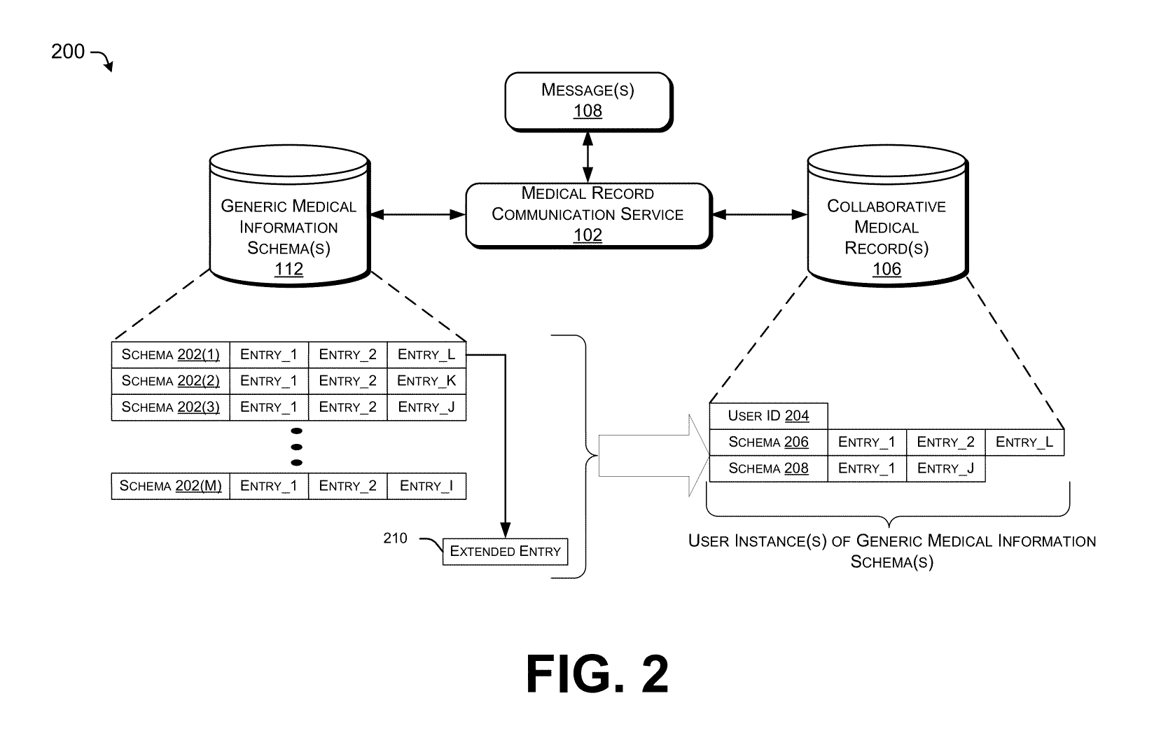

FIG. 2 illustrates generic medical information schemas 112 used by the medical record communication service 102 to retrieve and/or store user-specific medical information from a collaborative medical record 106 in response to receiving a message 108. FIG. 2 shows generic medical information schemas 202(1) . . . 202(M) (where M is an integer number). The medical record communication service 102 uses the generic medical information schemas 202(1) . . . 202(M) to determine and/or understand the user-specific medical information being provided via the message 108. Moreover, the medical record communication service 102 uses the generic medical information schemas 202(1) . . . 202(M) to generate and extend a collaborative medical record 106 for a user. For example, the medical record communication service 102 may use the generic medical information schemas 202(1) . . . 202(M) as a guide to organize (e.g., consolidate, de-duplicate and/or normalize) and store user-specific medical information in a user's collaborative medical record 106.

The generic medical information schemas 202(1) . . . 202(M) are independently generated so that related medical information can be organized and grouped together, e.g., via a generic medical information schema. Thus, the medical record communication service 102 may generate a first generic medical information schema 202(1) to organize first related medical information, a second generic medical information schema 202(2) to organize second related medical information, a third generic medical information schema 202(3) to organize third related medical information, an Mth generic medical information schema 202(M) to organize Mth related medical information, and so forth. Medical information may be related if the information is associated with, for example, a health condition (e.g., symptoms, medications, previous treatments, previous doctors, etc.) or a particular type or class of information (e.g., medication prescriptions for users, dates of doctor's appointments, etc.). In one example, medical information may be related if the information is part of a same form or set of forms used by a medical service provider. Each type or class of medical information may be associated with a specific generic medical information schema. For example, the medication prednisone may be associated with its own generic medical information schema.

The medical record communication service 102, via the generic medical information schemas 202(1) . . . 202(M), organizes and stores related medical information for a user so that it can be efficiently and reliably be retrieved and provided to a medical service provider (e.g., one of 104(1) . . . 104(N)) in a preferred format (e.g., one of 110(1) . . . 110(N)) of the medical service provider.

To organize and store the related medical information, the medical record communication service 102 generates generic schemas 202(1) . . . 202(M) by defining entries (referred to herein as a “generic entry” or “generic entries”) for the generic schemas 202(1) . . . 202(M). For instance, the first generic schema 202(1) includes generic entries 1 through L, the second generic schema 202(2) includes generic entries 1 through K, the third generic schema 202(3) includes generic entries 1 through J, and the Mth generic schema 202(M) includes generic entries 1 through I (e.g., L, K, J and I are integer numbers that may be the same or different).

Each generic entry in a generic schema may be defined to represent an electronic place or spot for a data element (also referred to herein as an “element”) to be stored. For example, if the generic schema is for “prednisone,” a generic entry may be for “dosage.” The generic entry in the generic schema may map to entries (referred to herein as “instance entries”) in one or more user instance schemas, which may in turn be associated with stored data elements. Continuing with the example, the “dosage” instance entries in multiple user instance schemas may be associated with different values (e.g., 10 mg, 20 mg, etc.). In another example, schema 202(1) may be a generic “medication” schema with generic entry_1 being defined to represent a “medication type” and generic entry_2 being defined to represent “dosage” of a medication type. Instance entries of a user instance schema mapped to generic entry_1 and generic entry_2 of the generic medication schema 202(1) may store or hold data elements specifying one of numerous different medication types (e.g., metformin, modafinil, diazepam, etc.) and a variable value for the dosage of the medication type consumed.

Consequently, the medical record communication service 102 uses the organization and structure of the generic schemas 202(1) . . . 202(M) to generate and maintain a collaborative medical record for a specific user. The medical record communication service 102 does this by creating a user instance of a generic schema in response to receiving user-specific medical information (e.g., data elements) associated with the generic entries defined for a generic schema.

FIG. 2 shows user instances of generic medical information schemas (e.g., user instance schemas). The user instance schemas may be part of a collaborative medical record 106 associated with a user identification (ID) 204. The user may be identified via the message 108 received by the medical record communication service 102 (e.g., a requesting message or a providing message). For example, user instance schema 206 may correspond to generic schema 202(1) and user instance schema 208 may correspond to generic schema 202(3).

In various implementations, the medical record communication service 102 is configured to create an instance entry in a user instance schema only if there is a data element to store for the user. Continuing the example from the preceding paragraph, the collaborative medical record for user ID 204 includes a data element to be stored in association with each of generic entry_1, generic entry_2, and generic entry_L of generic schema 202(1) (as illustrated by user instance entry_1, user instance entry_2 and user instance entry_L in user instance schema 206). However, the collaborative medical record for user ID 204 does not include an instance entry_2 that maps to generic entry_2 of generic schema 202(3) because no user-specific medical information associated with generic entry_2 (e.g., of the defined type or class) has been received. In contrast, the collaborative medical record for user ID 204 is generated to include user instance entries that map to generic entry_1 and generic entry_J of generic schema 202(3) (as illustrated by user instance entry_1 and user instance entry_J in the user instance schema 208) as a result of receiving user-specific medical information associated with generic entry_1 and generic entry_J of generic schema 202(3).

The medical communication service 102 may be configured to add a user instance schema to a collaborative medical record upon a provision of relevant user-specific medical information. For example, a generic “allergies” schema (e.g., generic schema 202(3)) may be instantiated in a user's collaborative medical record (e.g., as user instance schema 208) if the user visits a medical service provider to treat allergies and user-specific allergy information is provided to the medical record communication service 102. However, a generic “diabetes” schema (e.g., generic schema 202(2)) may not be instantiated in the user's collaborative medical record if the user does not have diabetes and has not visited a medical service provider to treat diabetes. Consequently, the collaborative medical record for user ID 204 does not include a user instance schema of the generic diabetes schema (e.g., generic schema 202(2)).

Accordingly, the medical record communication service 102 is configured to extend a user's collaborative medical record with additional user instance entries and/or additional user instance schemas as relevant user-specific medical information is received and collected, e.g., provided by a medical service provider.

In various implementations, the medical record communication service 102 may extend a generic medical information schema by adding an extended entry 210. For example, the medical record communication service 102 may receive a message associated with a form that includes data elements for a medication type field, a dosage field, a start date field, and a consumption schedule field. The generic medication information schema (e.g., generic schema 202(1)) may currently define a “medication type” (e.g., generic entry_1), a “dosage” (e.g., generic entry_2) and a “start date” (e.g., generic entry_L) but the generic medication schema may not currently have a generic entry defined for a “consumption schedule”. Thus, the medical record communication service 102 may determine that a new format requesting and/or providing new medical information related to the generic medication schema (e.g., a new type of element) has been received and may extend a generic schema by adding an extended generic entry 210 for the consumption schedule (e.g., where a data element may specify “once a week”, “once a day”, “twice a day”, etc.). Once the extended generic entry 210 is defined and added to the generic medication schema, it is available for instantiation in collaborative medical records of multiple different users.

The user ID 204 may identify the individual person associated with a message (e.g., a patient) via a name, a social security number or part of a social security number, a piece of contact information (e.g., a phone number, a post address, an email address, etc.), a patient identifier or master record number, an email, a phone number, or any other identifying information.

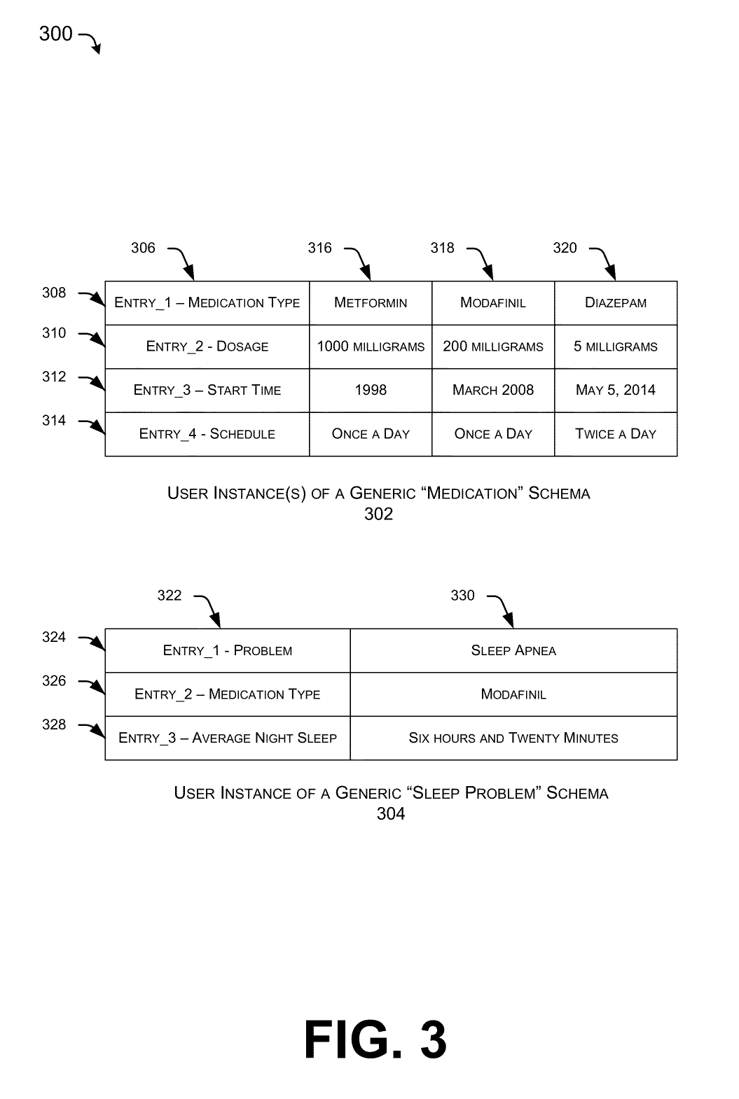

FIG. 3 illustrates an example diagram that shows example user instances of generic medical information schemas that contain user-specific medical information comprising at least part of a collaborative medical record for an individual user. For example, the collaborative medical record includes user instances of the generic medication schema 302, as discussed above, and a user instance of a generic “sleep problem” schema 304.

The column referenced by 306 shows the generic entries of a generic medication schema. As mentioned above, the generic entries are defined such that they are applicable to multiple users for which collaborative medical records are maintained and stored. The generic entry referenced by 308 corresponds to medication type, the generic entry referenced by 310 corresponds to dosage, the generic entry referenced by 312 corresponds to a start time when the user began taking the medication, and the generic entry referenced by 314 corresponds to a consumption schedule. The columns referenced by 316, 318 and 320 each represent an individual user instance of the generic medication schema. Thus, this user is currently taking metformin, modafinil and diazepam and user-specific medical information related to the consumption of these medications is provided via the user instance schemas referenced by 316, 318 and 320 (e.g., user-specific data elements are stored in user instance entries that correspond, e.g., map, to the generic entries).

The medications shown may be prescribed by different medical service providers, and thus, the medical record communication service 102 uses the generic medication schema to consolidate related information (e.g., medications currently being consumed by a patient). The consolidated information may subsequently be accessed and provided to another medical service provider, e.g., a doctor that may want to know what medications a patient is currently taking before treating the patient, such information being the complete consolidation of all the medications prescribed to the patient regardless of who prescribed it. Accordingly, the medical information communication service 102 may pull the information in user instance schemas referenced by 316, 318 and 320 for a pre-appointment form (e.g., a check-in form) and provide the information to a device located at a doctor's office or a user device (e.g., a smartphone, a tablet device etc.). Stated another way, the check-in form may request types of medications currently being taken by the user and instead of the user having to remember and list each type of medication, dosage, start date, etc., the medical information communication service 102 can efficiently pull the user-specific medical information from a collaborative medical record and reliably provide the information in a format preferred by a medical service provider. As an example, the preferred format may only ask for medication type and dosage, and thus, even though the collaborative medical record of the user has been extended to store data elements associated with a start time and a consumption schedule, the medical information communication service 102 may only retrieve the data elements associated with medication type and dosage. In another example, the preferred format may ask for dosage in milliliters, and thus, the medical information communication service may convert milligrams (e.g., which may be the “normalized” unit or metric used to store data elements) to milliliters.

Moving on, the column referenced by 322 shows the generic entries of a generic sleep problem schema. The generic entry referenced by 324 corresponds to a sleep problem or issue (e.g., a condition, a description, keywords, etc.), the generic entry referenced by 326 corresponds to medication type currently being consumed to treat or help with the sleep problem, and the generic entry referenced by 328 corresponds to an average amount of sleep per night (e.g., a doctor that treats sleep problems may want to know this information). The column referenced by 330 represents a user instance of the generic sleep problem schema with data elements specific to a user.

As seen in the examples discussed above with respect to FIG. 3, a collaborative medical record may include one user instance schema of a generic schema (e.g., the generic sleep problem schema) and/or multiple user instance schemas of a same generic schema (e.g., the generic medication schema). Moreover, a generic entry and user instance entry may be present in more than one respective generic schema or user instance schema. For example, in FIG. 3, the generic medication type entry is present in both the generic medication schema and the generic sleep problem schema (e.g., “modafinil” is user-specific medical information to be stored in two user instance schemas associated with different generic schemas).

FIG. 4 illustrates a diagram of a component level view of a computing device 400 of the medical record communication service 102 and/or of a computing device 400 that executes the medical record communication service 102. As illustrated, the computing device 400 comprises a system memory 402 storing a message reception module 404, a schematization module 406, a message provision module 408, a medical forms module 410, the collaborative medical records 106, and the generic medical information schema(s) 112. In various examples, system memory 402 may be volatile (such as RAM), non-volatile (such as ROM, flash memory, etc.) or some combination of the two.

As used herein, the term “module” is intended to represent example divisions of the software for purposes of discussion, and is not intended to represent any type of requirement or required method, manner or organization. Accordingly, while various “modules” are discussed, their functionality and/or similar functionality could be arranged differently (e.g., combined into a fewer number of modules, broken into a larger number of modules, etc.). Further, while certain functions and modules are described herein as being implemented by software and/or firmware executable on one or more processors across one or more devices, in other embodiments, any or all of the modules may be implemented in whole or in part by hardware (e.g., as an ASIC, a specialized processing unit, etc.) to execute the described functions. In other instances, the functions and/or modules are implemented as part of a device driver, firmware, and so on.

The message reception module 404 is configured to receive a message 108 from one of various medical service providers (e.g., one of medical service providers 104(1) . . . 104(N)) or another source 105. As discussed above, the message may be a requesting message or a providing message and the message may comprise, or in some way be associated with, a form such that the information requested or provided relates to fields of the form. The message reception module 404 may further be configured to analyze or parse the message to determine and/or identify a user (e.g., a user ID as previously discussed), a source of the message (e.g., a medical service provider such as a doctor or a doctor's office), and/or individual data elements requested or provided (e.g., the data elements comprise the user-specific medical information being requested or provided). For example, the message reception module 404 may analyze a message and determine that the form is requesting current medication types being consumed, a dosage, and a start time. In another example, the message reception may analyze a message and determine that the form is providing user-specific medical information related to medication (e.g., the doctor prescribes a new medication, the doctor updates or increases a dosage of a medication already being taken, etc.).

The schematization module 406 is configured to use the generic medical information schema(s) 112 to organize user-specific medical information to be stored. For instance, the schematization module 406 may consolidate related user-specific medical information (e.g., medication information) by determining that data elements provided via a message are associated with a generic medical information schema (e.g., a data element maps to a generic entry in the generic schema). Based on the data elements provided in the message, the schematization module 406 may: create a user instance schema in a user's collaborative medical record (e.g., a new medication type and dosage are received for a patient, the patient visits a sleep doctor for the first time, etc.), add a user instance entry to a user instance schema that is already part of user's collaborative medical record (e.g., add a user instance entry for a medication consumption schedule), or update a user instance entry that is already part of user's collaborative medical record (e.g., update a stored medication dosage with a new dosage). The schematization module 406 may use an identifier to associate separate user instance schemas of the same generic schemas so that the user-specific medical information can be efficiently and reliably retrieved, e.g., different medication type information.

Additionally, the schematization module 406 may determine that a data element provided is a duplicate of a data element already stored (e.g., a redundant element, a repetitive element), and therefore, may not store the data element in the collaborative medical record of a user. For example, a first doctor may prescribe a medication that the schematization module 406 stores in the user's collaborative medical record and a second doctor may request and be provided with the medication prescribed by the first doctor. Upon completion of an appointment, the second doctor may then re-list, on a form, the medication prescribed by the first doctor and not change any related medication information (e.g., dosage) and submit the form in a message to the medical information communication service 102. Thus, the schematization module 406 can determine that the original source of the prescription is the first doctor and the information associated with the prescription is already stored in a user instance schema of the user's collaborative medical record, and therefore, the medication re-listed on the form from the second doctor is a duplicate and does not need to be stored or re-stored in a separate user instance schema of the user's collaborative medical record.

In an implementation where the schematization module 406 is unable to determine if a data element or a form containing multiple data elements is a duplicate (e.g., due to conflicting information), the schematization module 406 may be configured to generate a prompt or a message to an individual (e.g., the patient, a doctor, etc.) that may be able to resolve the conflict. For example, the schematization module 406 may provide a prompt to the user when the user logs into an account from a user device, the prompt asking the user if a first one or more data elements are a duplicate of a second one or more data elements. In another example, e.g., if approved by an account setting, the schematization module 406 may generate a secured message (e.g., a text, an email, etc.) and send the secured message, e.g., to a user device, requesting that the user resolve the conflict.

The schematization module 406 may further be configured to normalize data elements to be stored in a collaborative medical record (e.g., convert a preferred format attribute of a medical service provider to a standard or normalized attribute and vice versa). For example, the schematization module 406 may be configured to: convert between metric units (e.g., milligrams vs. milliliters), convert between date sequences (e.g., 06-13-2014, 2014-06-13, Jun. 13, 2014), translate naming conventions (e.g., a technical name of a medication vs. a common name of the medication), mapping across coding systems (e.g. ICD, CPT, HCPCS), etc.

In further implementations, the schematization module 406 may translate or convert medical information into a normalized format and then determine, post translation or post conversion, that the medical information is a duplicate. For example, the schematization module may convert a dosage of a medication from milligrams to milliliters and then determine that the converted dosage in milliliters matches a dosage currently stored in the user's collaborative medical record, and thus, is a duplicate.

The message provision module 408 is configured to provide a response message to a medical service provider from which a message is received. For example, the message provision module 408 may provide the user-specific medical information requested in the format preferred by the medical service provider.

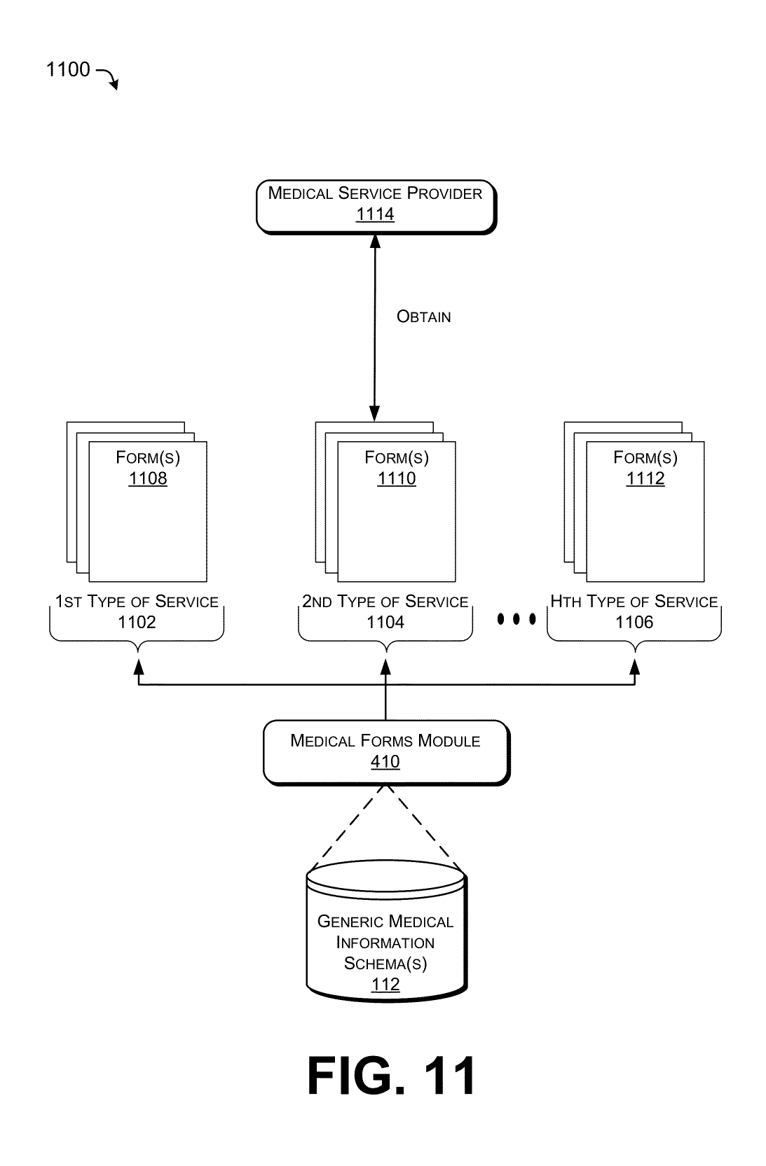

The medical forms module 410 is configured to offer, as a service to third-party medical information providers (e.g., one of medical service providers 104(1) . . . 104(N)), forms that are generated to include fields associated with generic entries defined in the generic medical information schema(s) 112, as further discussed herein with respect to FIG. 11.

The computing device 400 may also include processor(s) 412, a removable storage 414, a non-removable storage 416, input device(s) 418, output device(s) 420, and communication connections 422 to one or more other computing devices 424 and/or external database(s) that maintain the collaborative medical records 106 and the generic medical information schema(s) 112.

In some examples, the processor(s) 412 may be a central processing unit (CPU), a graphics processing unit (GPU), or both CPU and GPU, or any other sort of processing unit.

The computing device 400 may also include additional data storage devices (removable and/or non-removable) such as, for example, magnetic disks, optical disks, or tape. Such additional storage is illustrated in FIG. 4 by removable storage 414 and non-removable storage 416.

Non-transitory computer-readable media may include volatile and nonvolatile, removable and non-removable tangible, physical media implemented in technology for storage of information, such as computer readable instructions, data structures, program modules, or other data. System memory 402, removable storage 414 and non-removable storage 416 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the computing device 400. Any such non-transitory computer-readable media may be part of the computing device 400.

In various examples, input devices 418 may include any sort of input devices known in the art. For example, input devices 418 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

In some examples, the output devices 420 may include any sort of output devices known in the art, such as a display (e.g., a liquid crystal display), speakers, a vibrating mechanism, or a tactile feedback mechanism. Output devices 420 may also include ports for one or more peripheral devices, such as headphones, peripheral speakers, or a peripheral display.

Computing device 400 also contains communication connections 422 that allow the computing device 400 to communicate with other computing devices 424, such as device(s) associated with the medical service providers 104(1) . . . 104(N), devices associated with maintenance of the medical records 106, devices associated with recipients of medical service (e.g., a patient for which a collaborative medical record is maintained), etc. As described above with reference to FIG. 1, these communication connections 422 may be established and/or secured in accordance with one or more standards, protocols, specifications, or techniques to enable secure communication of medical information among the various devices.

The modules and data shown in FIG. 4 may also comprise any sort of applications or platform components of the computing device 400, as well as data associated with such applications or platform components.

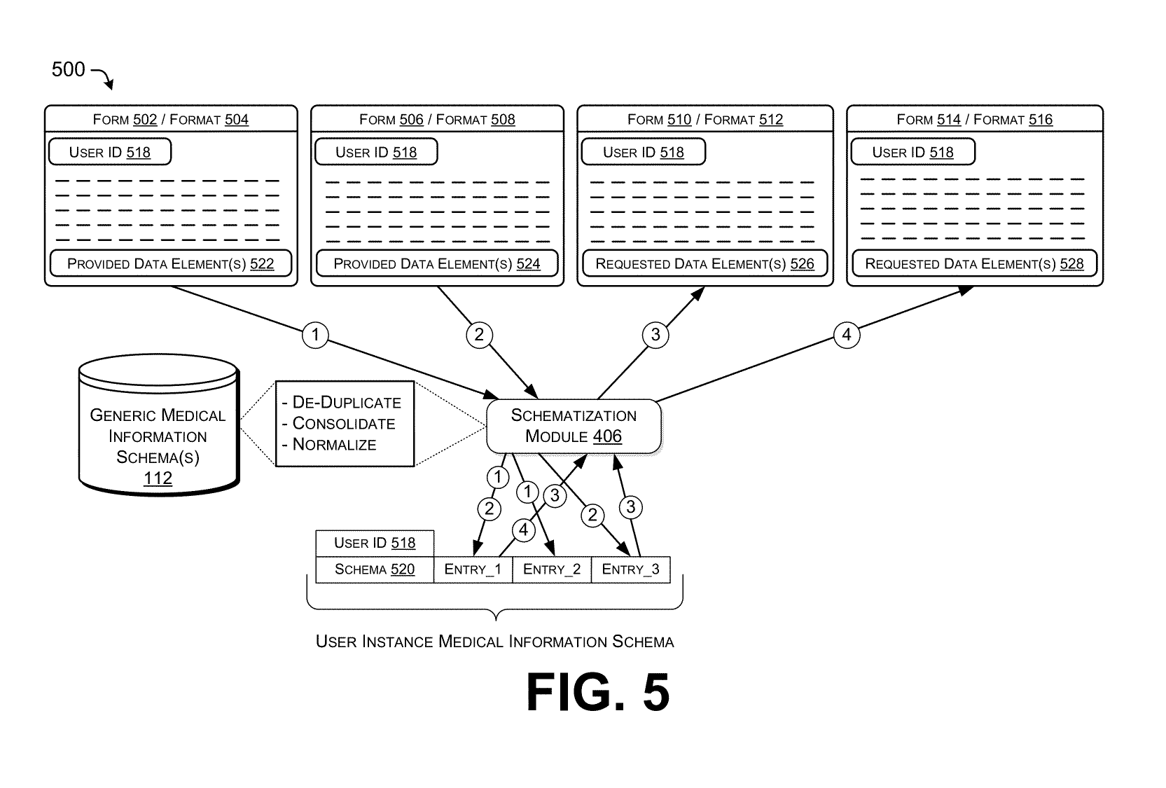

FIG. 5 illustrates an example diagram 500 that shows interactions with a user instance of a generic medical information schema to store and/or retrieve user-specific medical information for varying forms and/or varying formats. FIG. 5 illustrates a first form 502 in a first format 504, a second form 506 in a second format 508, a third form 510 in a third format 512, and a fourth form 514 in a fourth format 516. As discussed above, the forms may be used by different medical service providers or another source 105 to provide information to a collaborative medical record associated with a user ID 518 and retrieve information from the collaborative medical record (e.g., a user instance schema 520 contained in the collaborative medical record). While four forms with different formats are shown in FIG. 5, it is understood in the context of this document, that the schematization module 406 can interact with any number of different forms.

The forms in FIG. 5 may be received sequentially over a period of time and may provide data elements and request data elements from the same user instance schema 520. For instance, form 502 is shown to first provide data elements 522 to the schematization module 406 and the data elements provided via form 502 are represented by a “1”. Upon receiving form 502, the schematization module 406 may map the provided data elements 522 to a generic medical information schema 112 and if the data elements are new elements, the schematization module 406 may create a new user instance schema 520 or new entr(ies) in an existing user instance schema 520. In some examples, the schematization module 406 will consolidate the new user instance schema (e.g., a new prescribed medication) with other user instance schemas of the same generic schema type (e.g., other prescribed medications). For form 502, the schematization module 406 is configured to store the provided data elements 522 in user instance entry 1 (e.g., a medication type such as metformin) and user instance entry 2 (e.g., a medication dosage such as 1000 milligrams) of user instance schema 520 (e.g., as referenced by the directional arrows labeled with a “1”), and thus, the user instance schema 520 at first is generated to only include user instance entry 1 and user instance entry 2, e.g., based on a form 502 received from a first doctor.

After receiving form 502, the schematization module may receive form 506 at a later time. Form 506 is shown to provide data elements 524 to the schematization module 406 and the data elements 524 provided via form 506 are represented by a “2”. These data elements 524 may be provided by a different doctor or generated by the patient or his/her caregiver. Accordingly, the schematization module 406 may determine that a first data element of the provided data elements 524 corresponds to user instance entry 1 in user instance schema 520 (e.g., as referenced by a directional arrow labeled with a “2”). The schematization module 406 may also determine, via the generic medical information schema, that the data elements 524 include a new data element that is not yet defined for the user instance schema (e.g., form 506 may indicate metformin and a starting date when the user began taking metformin). Thus, the schematization module 406 may add a new user instance entry of a generic schema entry (e.g., a “starting date” entry) to the user instance schema 520 (e.g., entry 3) so that the new data element can be stored (as represented by the direction arrow labeled with a “2”). Thus, the user instance schema is extended to include a user instance entry that maps to a generic entry defined in a generic medical information schema.

In various implementations, the schematization module 406 may determine that the data element provided by form 506 to user instance entry 1 is a duplicate of the data element already stored in entry 1 by form 502. Thus, the schematization module 406 may determine that the medication type is the same and that another user instance schema does not need to be created based on form 506.

Form 510 is shown to request data elements 526 from the schematization module 406 and the data elements requested via form 510 are represented by a “3”. In response to receiving form 510, the schematization module 406 may determine the data elements being requested (e.g., entry 1 and entry 3 in user instance schema 520 as shown by the arrows labeled with a “3”) and retrieve the data elements requested so they can be sent to a medical service provider, e.g., to fill-in fields of form 510.

Form 514 is shown to request data elements 528 from the schematization module 406 and the data elements requested via form 514 are represented by a “4”. In response to receiving form 514, the schematization module 406 may determine the data elements being requested (e.g., entry 1 in user instance schema 520 as shown by the arrows labeled with a “4”) and retrieve the data element requested so it can be sent to a medical service provider, e.g., to fill-in fields of form 514.

Consequently, the schematization module 406 uses the definitions and structure of a generic medical information schema to continue to generate (e.g., expand) and update user instance schemas as relevant user-specific information is provided. Once stored, the data elements in user instance entries are retrievable by other forms or other medical service providers.

In various implementations, the schematization module 406 is configured to provide user-specific medical information beyond that requested. For example, in FIG. 5, form 510 requests that the data elements corresponding to user instance entry 1 (e.g., a medication type—metformin) and user instance entry 3 (e.g., a starting date—1998) be retrieved. The schematization module 406 can determine that the collaborative medical record for user ID 520 stores additional information for this medication, e.g., user instance entry 2 which indicates a currently prescribed dosage of meformin. Thus, the schematization module 406 may be configured to provide additional relevant user-specific medical information associated with the information requested.

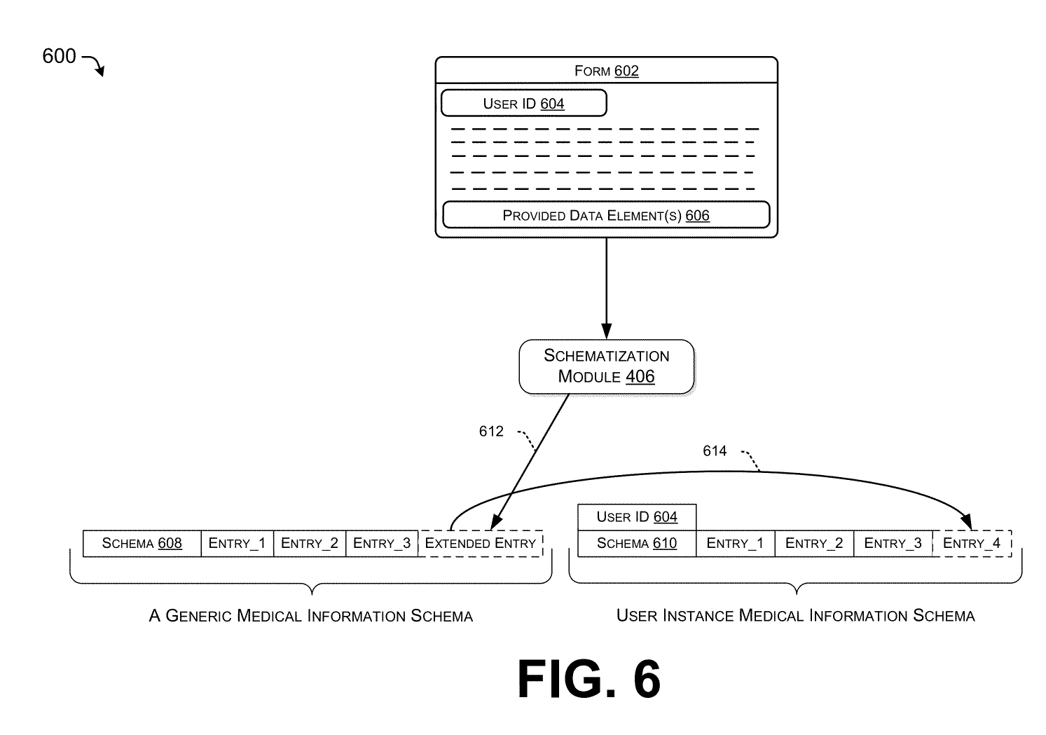

FIG. 6 illustrates an example diagram 600 that shows a generic medical information schema being extended. In FIG. 6, the schematization module 406 receives a form 602 associated with user ID 604. The form provides data elements 606. Some of the provided data elements 606 may correspond to generic entries (e.g., entry 1, entry 2, entry 3) of a generic schema 608 for which user instance entries in a user instance schema 610 have already been generated (e.g., entry 1, entry 2, and entry 3). However, form 602 may have been provided by a medical service provider that wants to store, and/or share with others, a new data element that does not correspond to a generic entry in the generic medical information schema 608.

Accordingly, the schematization module 406 is configured to organize and consolidate related medical information by extending the generic medical information schema, e.g., add an extended entry referenced by 612. The schematization module 406 may then create a user instance entry (e.g., entry 4) in the user instance schema 610 as referenced by 614 and store the new data element in the new user instance entry, e.g., entry 4.

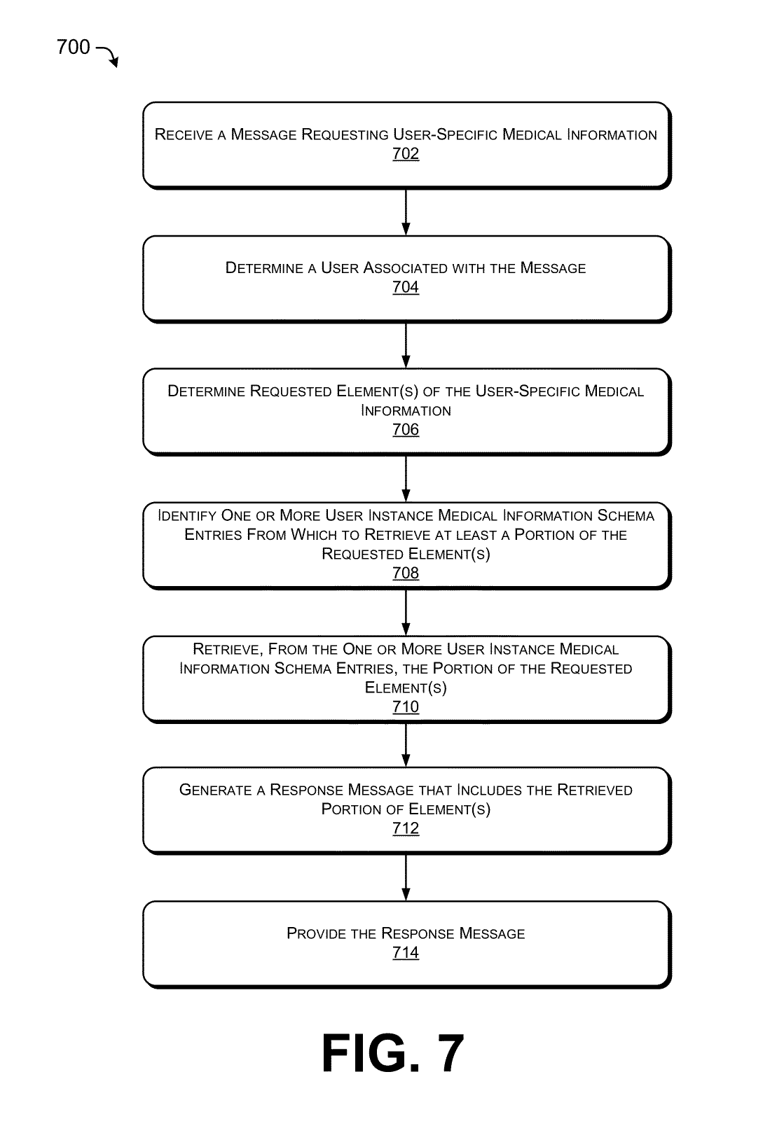

FIGS. 7-10 illustrate example processes. These processes are individually illustrated as logical flow graphs, each operation of which may be represented in a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

FIG. 7 illustrates an example process 700 that retrieves and provides user-specific medical information in response to receiving a request. The example process 700 may be implemented in accordance with elements and/or features in any one of FIGS. 1-6.

At 702, the message reception module 404 receives a message requesting user-specific medical information. For instance, the message requesting medical information may comprise, or be associated, with a form used by a medical service provider to obtain medical information for a patient such as information associated with previous appointments, conditions treated by other medical service providers, medications prescribed by other medical service providers, etc. In one example, the form may be associated with an appointment with a healthcare professional (e.g., an appointment check-in form a doctor's office has a patient submit before the appointment, an appointment scheduling form a doctor's office has a patient submit when scheduling the appointment, etc.).

At 704, the message reception module 404 may determine a user associated with the message. For example, the message reception module 404 may analyze the message to identify an individual person receiving the service or care from the medical service provider (e.g., the user ID shown in one of FIG. 2 or FIG. 5). The message reception module 404 may also analyze the message to identify an individual or entity that is the source of the message (e.g., a medical service provider such as a doctor, a physician's assistant, a clinic, a hospital).

At 706, the message reception module 404 may analyze the message to identify different elements of user-specific medical information being requested (e.g., the data elements requested as discussed above with respect to one of FIG. 2 or FIG. 5). As discussed above, the data elements requested may be specific to the form and/or a format preferred by the medical service provider making the request (e.g., amount of information, text or terminology, metric units, etc.).

At 708, the schematization module 406 identifies one or more user instance medical information schema entries from which to retrieve at least a portion of the requested elements. For example, the schematization module 406 may map a requested element to a user instance entry. Accordingly, the schematization module 406 may create a link between an element requested and one or more user instance entries that contain data specific to a user identified by the message.

At 710, the schematization module 406 retrieves, from the identified user instance medical information entries (e.g., of the collaborative medical record of the user), at least the portion of the requested elements (e.g., the collaborative medical record may not contain the information requested).

At 712, the schematization module 406 generates a response message that at least includes the retrieved portion of elements. The schematization module 406 is configured to generate the message so that the retrieved medical information is formatted according to a preference of the medical service provider. In various implementations, the retrieved information may contain additional related medical information that was not requested via the message, as discussed above.

At 714, the message provision module 408 provides the response message to the medical service provider.

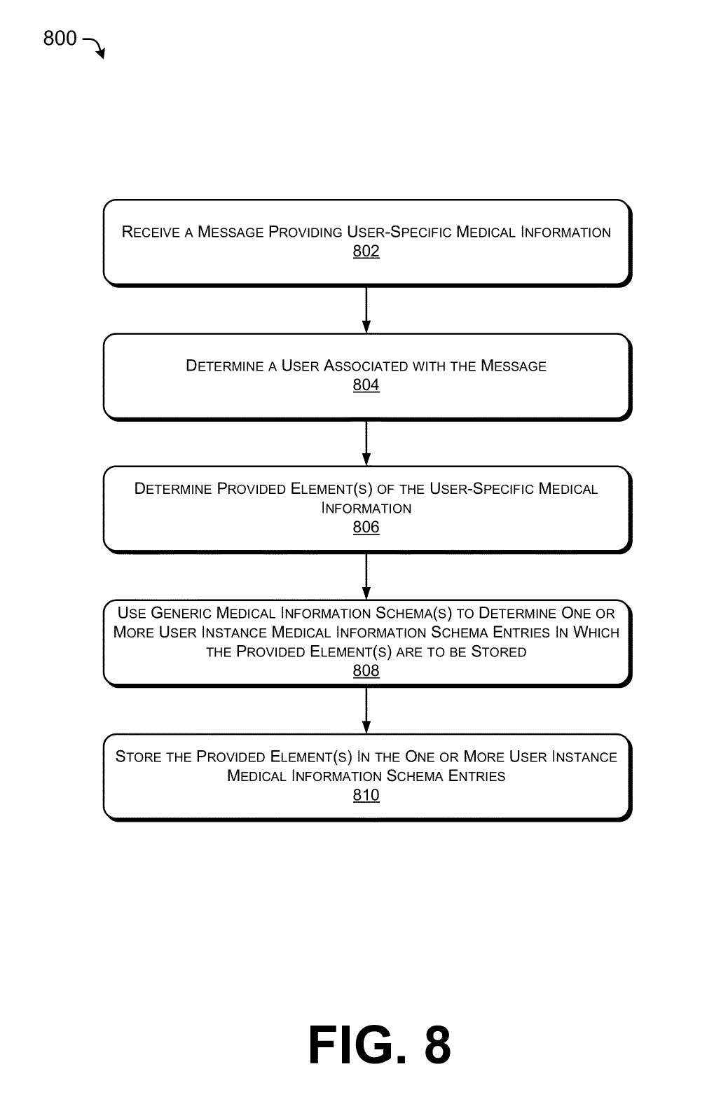

FIG. 8 illustrates an example process 800 that uses a generic medical information schema to store user-specific medical information in a collaborative medical record in response to receiving the user-specific medical information, e.g., from a medical service provider or another source 105. The example process 800 may be implemented in accordance with elements and/or features in any one of FIGS. 1-7.

At 802, the message reception module 404 receives a message providing user-specific medical information. For instance, the message providing medical information may comprise, or be associated, with a form used by a medical service provider to store medical information.

At 804, the message reception module 404 may determine a user associated with the message.

At 806, the message reception module 404 may analyze the message to identify different elements of user-specific medical information being provided (e.g., the data elements provided as discussed above with respect to one of FIG. 2, FIG. 5 or FIG. 6). As discussed above, the data elements provided may be in a format specific to a form and/or a medical service provider (e.g., amount of information, text or terminology, metric units, etc.).

At 808, the schematization module 406 uses one or more generic medical information schemas to determine one or more user instance medical information schema entries in which the provided elements are to be stored. For example, the schematization module 406 may map a provided data element to a generic entry in the generic medical information schema and then determine a corresponding user instance entry in which to store a data element. In various implementations, the schematization module 406 may access the generic medical information schema to determine a generic entry to add to a user instance schema. Stated another way, if the user instance schema does not have a current user instance entry in which a data element can be stored, the schematization module can extend the user instance schema by adding a new user instance entry associated with a generic entry defined in a generic schema. In various implementations, the schematization module 406 may determine that a data element does not correspond to a generic entry in the generic schema, and therefore, the schematization module 406 may extend the generic schema to include a new generic entry based on a type of the data element.

At 810, the schematization module 406 stores the provided elements in the one more user instance medical information schema entries.

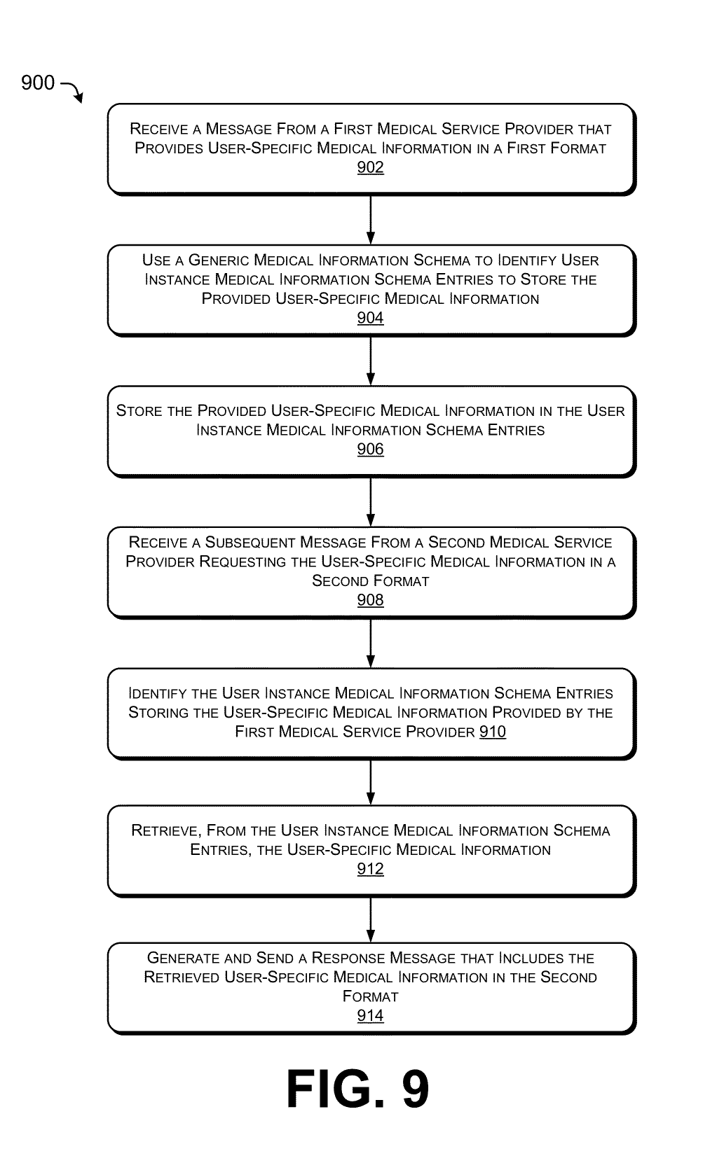

FIG. 9 illustrates an example process 900 that uses a generic medical information schema to store user-specific medical information received from a first medical service provider in a first format and to retrieve the stored user-specific medical information so that it can be provided to a second medical service provider in a second format that is different than the first format. The example process 900 may be implemented in accordance with elements and/or features in any one of FIGS. 1-8.

At 902, the message reception module 404 receives a message from a first medical service provider that provides user-specific medical information in a first format.

At 904, the schematization module 406 uses a generic medical information schema to identify user instance medical information schema entries in which to store the provided user-specific medical information.

At 906, the schematization module 406 stores the provided user-specific medical information in the user instance medical information schema entries.

At 908, the message reception module 404 receives a subsequent message from a second medical service provider requesting the user-specific medical information in a second format.

At 910, the schematization module 406 identifies the user instance medical information schema entries storing the user-specific medical information provided by the first medical service provider.

At 912, the schematization module 406 retrieves, from the user instance medical information schema entries, the user-specific medical information provided by the first medical provider.

At 914, the schematization module 406 and/or the message provision module 408 generate and send a response message that includes the retrieved user-specific medical information in the second format.

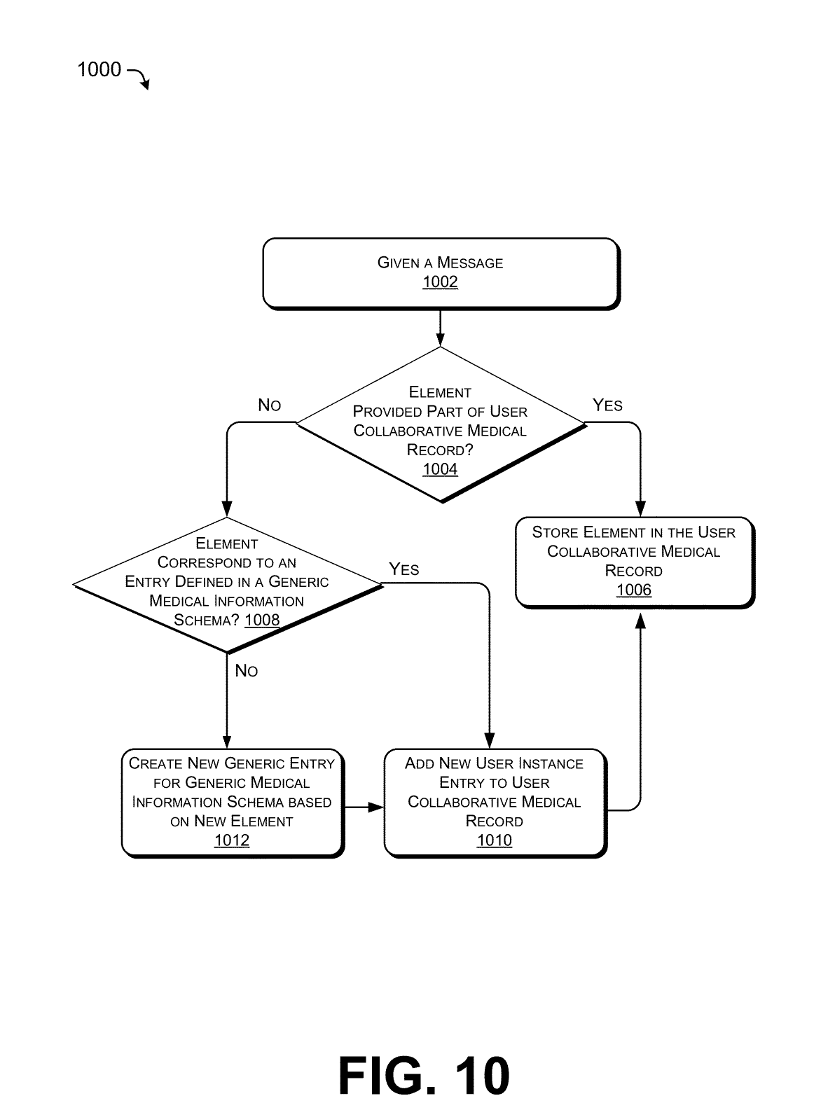

FIG. 10 illustrates an example process 1000 that extends a user instance medical information schema and/or extends a generic medical information schema. The example process 1000 may be implemented in accordance with elements and/or features in any one of FIGS. 1-9.

At 1002, the medical information communication service 102 is given a message (e.g., a message providing user-specific medical information).

At decision 1004, the schematization module 404 determines if an element provided is part of a user collaborative medical record (e.g., corresponds to a user instance entry of a user instance schema included in the user's collaborative medical record).

If “yes” at decision 1004, then at 1006 the schematization module 406 stores the element in the user collaborative medical record.

If “no” at decision 1004, then the process moves to decision 1008 where the schematization module 406 determines if the element corresponds to a generic entry defined in a generic medical information schema.

If “yes” at decision 1008, then at 1010 the schematization module 406 adds a new user instance entry to the user collaborative medical record, where the new user instance entry is associated with the generic entry, and the process proceeds to 1006 where the element is stored.

If “no” at decision 1008, then at 1012 the schematization module 406 may create a new generic entry for the generic medical information schema based on the new element. The process then proceeds to 1010 where a new user instance entry associated with the new generic entry is added to the user's collaborative medical record and the element is stored at 1006.

FIG. 11 illustrates an example diagram that provides a form service to medical service providers based on the generic medical information schemas. The medical forms module 410 is configured to generate forms that contain fields corresponding to generic entries in the generic medical information schemas.

For example, the medical forms module 410 may generate forms for a first type of service 1102, a second type of service 1104, and an Hth type of service (where H is an integer number). Accordingly, FIG. 11 shows a set of forms 1108 for the first type of service 1102, a set of forms 1110 for the second type of service 1104, and a set of forms 1112 for the Hth type of service 1106.

In an example, the set of forms 1108 for the first type of service 1102 may be forms associated to request or provide information related to alzheimer's disease. The set of forms 1110 for the second type of service 1104 may be forms associated with allergies, and a set of forms 1112 for the Hth type of service 1106 may be forms associated with sleeping habits. Based on this example, the medical forms module 410 generates the forms in light of different user-specific medical information that may be communicated to and from medical service providers for the different conditions specified above. Again, the forms are generated based on generic medical information schemas defined for the various conditions.

In various implementations, a medical service provider that offers care for a particular condition may obtain the forms (e.g., install the forms, subscribe to the forms, etc). For instance, continuing the example from the preceding paragraph, a medical service provider 1114 may treat allergies, and therefore, may obtain allergy forms 110. By obtaining allergy forms 110, which are based on generic medical information schemas related to allergies, patients of medical service provider 1114 may automatically have user instance schemas created in a collaborative medical record that organize medical information related to allergies.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computer-implemented method comprising:
receiving a message providing user-specific medical information;
determining one or more data elements that comprise the user-specific medical information;
identifying a generic entry of a generic medical information schema associated with at least one data element of the one or more data elements;
adding, based on the identified generic entry, a user instance entry to a user instance schema of a collaborative medical record, the user instance schema being associated with the generic medical information schema; and
storing the at least one data element in the user instance entry added to the user instance schema.

2. The computer-implemented method of claim 1, further comprising, prior to the identifying the generic entry, determining that the at least one data element is not associated with a current user instance entry that is already part of the user instance schema.

3. The computer-implemented method of claim 1, wherein the generic medical information schema is defined to organize related medical information.

4. The computer-implemented method of claim 1, further comprising:
determining that at least one other data element of the one or more data elements is a duplicate of a stored data element that is already part of the collaborative medical record; and
refraining from storing, in the collaborative medical record, the at least one other data element that is the duplicate of the stored data element.

5. The computer-implemented method of claim 1, wherein the generic medical information schema is used to create one or more user instance medical information schemas for one or more individual users of multiple users.

6. The computer-implemented method of claim 1, wherein the one or more data elements are part of a form used by a medical service provider to provide information to the collaborative medical record.

7. A computer-implemented method comprising:
receiving a message providing user-specific medical information;
determining one or more data elements that comprise the user-specific medical information;
determining that at least one data element of the one or more data elements fails to map to a corresponding generic entry in a generic medical information schema;
adding, based at least in part on an information type of the at least one data element, a new generic entry to the generic medical information schema;
adding, based at least in part on the new generic entry, a user instance entry to a user instance schema of a collaborative medical record, the user instance schema being associated with the generic medical information schema; and
storing the at least one data element in the user instance entry added to the user instance schema.

8. The computer-implemented method of claim 7, wherein the generic medical information schema is defined to consolidate related medical information.

9. The computer-implemented method of claim 7, wherein the generic medical information schema is used to create one or more user instance medical information schemas for one or more individual users of multiple users.

10. One or more non-transitory computer-readable media having stored thereon computer-executable instructions configured to program a computing device to perform operations comprising:
receiving a message that requests at least a portion of user-specific medical information in a first format;
identifying at least one user instance schema entry from which to retrieve the portion of the user-specific medical information, wherein the at least one user instance schema entry stores the user-specific medical information previously received from a medical service provider in a second format that is different from the first format;
retrieving, from the at least one user instance schema entry, the portion of the user-specific medical information;
generating, based at least in part on the first format, a response message that includes the portion of the user-specific medical information; and
sending the response message.

11. The one or more non-transitory computer-readable media of claim 10, wherein the operations further comprise:
prior to receiving the message, receiving a previous message from the medical service provider that provides the user-specific medical information in the second format; and
storing the user-specific medical information in one or more user instance schema entries, the one or more user instance schema entries including the at least one user instance schema entry.

12. The one or more non-transitory computer-readable media of claim 11, wherein the storing the user-specific medical information in the one or more user instance schema entries comprises normalizing the user-specific medical information.

13. The one or more non-transitory computer-readable media of claim 10, wherein the first format is associated with a first form and the second format is associated with a second form, and the first form and the second form vary based at least in part on an amount of the user-specific medical information.

14. The one or more non-transitory computer-readable media of claim 10, wherein the first format is associated with a first form and the second format is associated with a second form, and the first form and the second form vary based at least in part on naming conventions used for medically-related terms.

15. The one or more non-transitory computer-readable media of claim 10, wherein the first format is associated with a first form and the second format is associated with a second form, and the first form and the second form vary based at least in part on metric units used.

16. A system comprising:
one or more processors; and
a schematization module configured to be operated by the one or more processors to perform operations including:
generating a generic medical information schema that includes multiple generic entries; and
creating an instance of the generic medical information schema in each of multiple collaborative medical records respectively associated with multiple users, each instance including at least a subset of the multiple generic entries based at least in part on user-specific medical information received.

17. The system of claim 16, wherein the user-specific medical information received for an instance is received from a medical service provider.

18. The system of claim 16, wherein the user-specific medical information received for an instance is received from a user associated with the instance.

19. The system of claim 16, wherein:
a first instance of the generic medical information schema in a first collaborative medical record includes one or more first user instance entries associated with a first one or more generic entries of the multiple generic entries; and
a second instance of the generic medical information schema in a second collaborative medical record includes one or more second user instance entries associated with a second one or more generic entries of the multiple generic entries, the first one or more generic entries being different than the second one or more generic entries.

20. The system of claim 16, further comprising a medical forms module configured to be operated by the one or more processors to perform operations including:
generating one or more forms based at least in part on the generic medical information schema; and
permitting one or more medical service providers to use the one or more forms to request or provide the user-specific medical information based at least in part on the generic medical information schema.
